(19) United States
(12) Patent Application Publication
(10) Pub. No.: US 2009/0111299 A1
(43) Pub. Date: Apr. 30, 2009

(54) Surface Mount Array Connector Leads Planarization Using Solder Reflow Method

(75) Inventors: Michael J. Domitrovits, New Paltz, NY (US); Raymond F. Frizzell, JR., Staatsburg, NY (US); Wai Mon Ma, Poughkeepsie, NY (US); Cheikhou O. Ndiaye, Highland, NY (US); Nandakumar N. Ranadive, Wappinger Falls, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/866,728

(22) Filed: Oct. 31, 2007

(51) Int. Cl. H01R 12/00; B23K 1/20; B23K 31/02

(52) U.S. Cl. 439/83; 228/208

(57) ABSTRACT

A connector and method for making wherein the connector has a connector body, connector leads extending from the connector body for solder connection to an electronic circuit wherein the connector leads do not extend a uniform distance from the body connector body. A solder paste is formed on each connector lead by stenciling it onto a flat plate that is non-wettable to the solder paste. The solder paste is composed of first solder particles having a first lower melting point and second solder particles having a second higher melting point. The solder paste is heated to the first melting point for adhering the solder paste to the connector leads while planarizing the solder covered electrical leads with the flat plate. The connector leads are soldered to an electrical circuit by removing the flat plate and heating the solder paste to the second higher melting point.

### FIELD OF THE INVENTION

This invention relates to a method and system for surface mounting an area array connector on to a circuit board and, more particularly, to a method and system for planarization of the connector leads to facilitate the reliable joining of the connector to the circuit board using solder.

### BACKGROUND OF THE INVENTION

This invention solves the leads coplanarity and soldering problem of a surface mount array connector. A known solution to this problem is to apply a load 11 to the top of a connector 10 which will deflect leads 12 of the connector 10 to conform to the flat surface of a circuit board 19 during the solder attach reflow process as shown in FIG. 1. The drawback to such solution is the need for connector loading mechanism. The loading mechanism will add to the thermal mass of the reflow fixture. It becomes difficult to achieve the thermal profile needed for a reliable solder joint with the increased solder reflow fixture thermal mass. It is known that long duration to reach the proper flux activation and preheat temperature will degrade the effectiveness of the flux. The wettability of the bonding surfaces will be poor because of the weaken flux activity. It is desirable to provide a method and system to effectively solder bond the connector to the circuit board surface without the need of an external load applying mechanism.

U.S. Pat. No. 5,195,674 issued Mar. 23, 1993 to Nishi for REFLOW SYSTEM discloses a reflow system for heating solders temporarily attaching electronic components to a circuit board.

US Patent Application Publication 2004/0245648 A1 published Dec. 9, 2004 by Nagasawa et al. for BONDING MATERIAL AND BONDING METHOD discloses a bonding material and a bonding method which enable lead-free bonding that can replace high-temperature soldering. The material disclosed is a mixture of metallic nano-particles and an organic solvent. The bonding material can have two or more sintering temperatures.

US Patent Application Publication 2005/0243536 A1 published Nov. 3, 2005 by Chiba et al. for PRINTED CIRCUIT BOARD, PARTS MOUNTING METHOD AND MOUNTING POSITION VERIFYING METHOD discloses a printed circuit board that can suppress the positional displacement of parts mounted thereon. Spare marks are used for pre-alignment of components on the same circuit board prior to placing the components on the actual circuit board position for solder attach.

US Patent Application Publication 2006/0139902 A1 published Jun. 29, 2006 by Happoya for DOUBLE-SIDED COMPONENT-MOUNTED CIRCUIT BOARD AND METHOD FOR MANUFACTURING THE SAME discloses a double-sided component-mounted circuit board having a base shaped flatly and having a wiring pattern thereon with circuit components mounted on both faces of the base so as to be connected to the wiring pattern to configure the circuit. A rigid reinforcing member attaches to one side of the circuit board to facilitate the manufacture of a thin double sided surface mounted circuit board assembly.

Japanese Patent No. 02211995 A published Aug. 23, 1990 by Masaya et al. for PASTY SOLDER discloses a pasty solder for preventing a Manhattan phenomenon. The pasty solder is formed by mixing at least two kinds of solder particles of different melting points.

Japanese Patent No. 06140756 A published May 10, 1994 by Masao for CREAMY SOLDER AND MOUNTING OF ELECTRONIC CIRCUIT COMPONENT USING THE CREAMY SOLDER discloses a method for temporarily joining an electronic component to a circuit board using a solder paste alloy that has been mixed with higher melting conductive particles.

### SUMMARY OF THE INVENTION

In one embodiment, it is primary purpose on the present invention to planarize the surface mount leads of an array connector using a solder reflow method. The advantages of using this invention over known solutions are improved surface mount leads coplanarity of the connector without the need for an external loading mechanism to force the leads to the circuit board, no additional thermal mass added to the reflow fixture which will facilitates the solder reflow thermal profile process, increased surface mount connector yields from the connector supplier (coplanarity tolerance of the leads may be relaxed slightly prior to applying the planarization invention), reduced rework of non-conforming connectors at the supplier, reduced circuit board assembly cycle time (less fixturing and reflow duration), and reduced fixture cost

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of prior art;

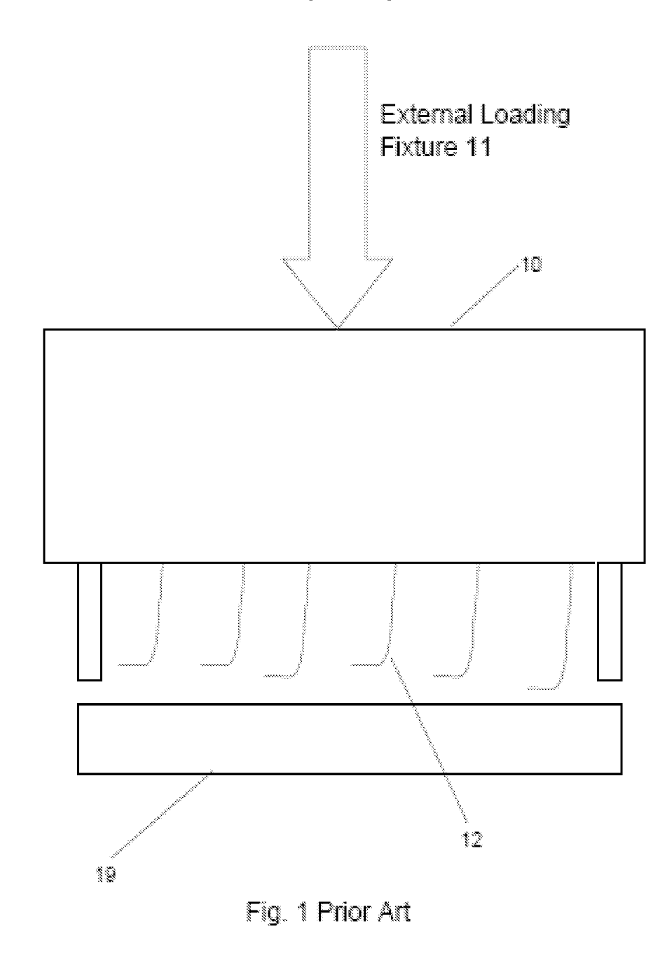

FIG. 2 illustrates one example of a connector with non-planarized leads;

FIG. 3 illustrates one example of the method and system to planarize the connector leads;

FIG. 4 illustrates one example of a connector with planarized leads; and

FIG. 5 is a flow diagram illustrating an embodiment of the method of planarization of the connector leads of the present invention.

The detailed description explains the preferred embodiments of the invention, together with advantages and features, by way of example with reference to the drawings.

### DETAILED DESCRIPTION OF THE INVENTION:

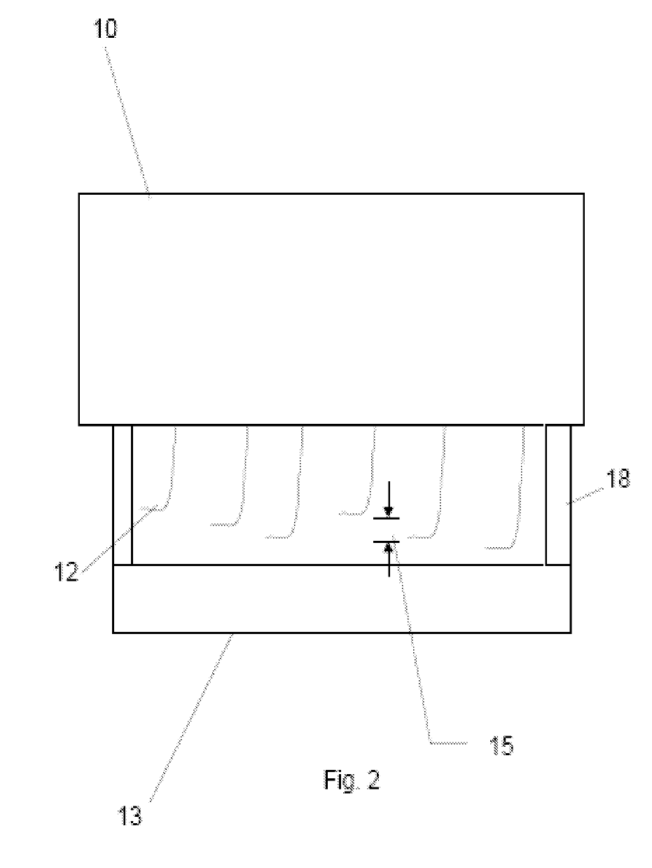

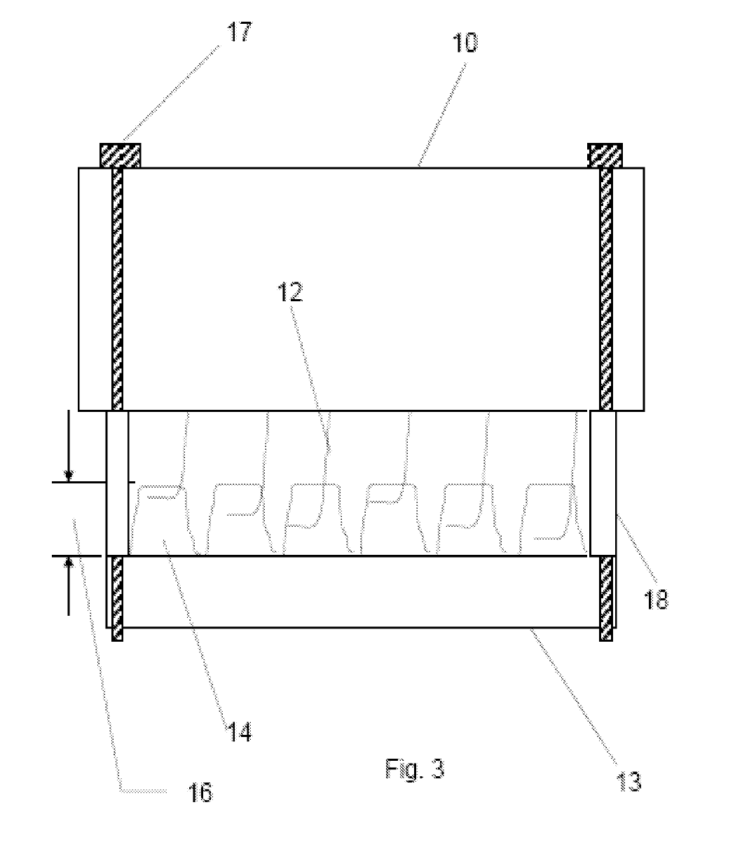

Referring to FIG. 2, the present device includes a connector 10, a flat plate 13 and connectors leads 12 extending from the connector 10. A solder paste pattern 14 is stenciled onto the flat plate 13 that has a non-wettable surface (i.e. polyamide film). The solder paste pattern forms contacts for soldering to an electronic circuit. The height of the stenciled solder paste pattern 14 is higher than the expected coplanarity gap 15 of the connector leads 12 as shown in FIG. 3. Referring to FIG. 2, the solder paste height 16 and volume is measured using an auto Laser Surface Micrometer to assure adequate solder height and volume for all the connector leads. The flat plate 13 and its non-wettable surface is able to withstand solder reflow temperatures.

The surface mount array connector 10 is mounted to the flat plate 13 using screws 17 that threads into connector guide blocks 18. It will be understood that this holds the connector 10 in contact with the solder paste 14 that is on the flat plate 13.

The fixtured connector 10 and flat plate assembly 13 is placed into a reflow oven. The oven is profiled to allow only the lower melting point solder particles to melt for a brief period of time above the melting point of the lower melt solder. The temperature and duration of the reflow process is controlled such that the higher melting solder particles do not melt. The resulting solder fillet structure will fill original coplanarity gaps 15 that were in the connector leads.

The “pasty range” of a slightly off-eutectic solder is used to create a coplanar surface on the leads of an array connector. The idea is to “freeze” the solder at the “pasty range” before it completely wets to the leads. These types of slightly off-eutectic solder remain viscous for a period of time at the lower melting point solder liquidus point. The solder paste used is a mixture of smaller size particles of low melting alloy (i.e. SnPbAg melts at 178 C) mixed with larger size particles of higher melting alloy (i.e. SnPb melts at 183 C). The smaller size low melt alloy will diffuse slower into the higher melt alloy and thus gain a longer time in the “pasty range”.

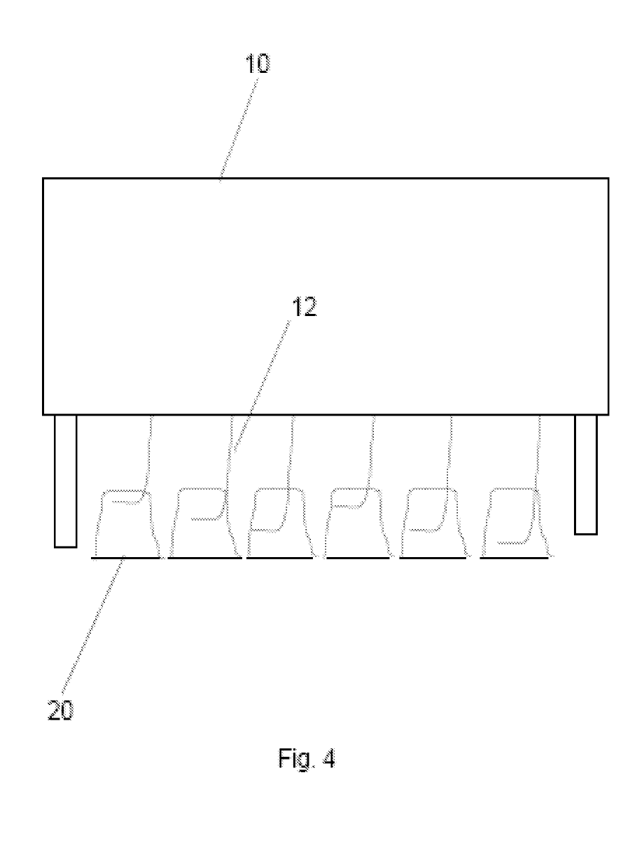

Referring to FIG. 4, the planarized leads 20 will have solder that is partially wetted to the leads 12. The solder on the lead 20 that is in contact with the non-wettable planar flat surface of 13 of FIGS. 2-3 will be a coplanar surface.

The planarized connector in FIG. 4 can now be soldered to a circuit board (not shown) using a standard surface mount process that will melt the higher melt solder particles thereby soldering the solder paste contacts 14 to the electronic circuit of the circuit board. The need of an external loading mechanism on the connector as used in the prior art is not required.

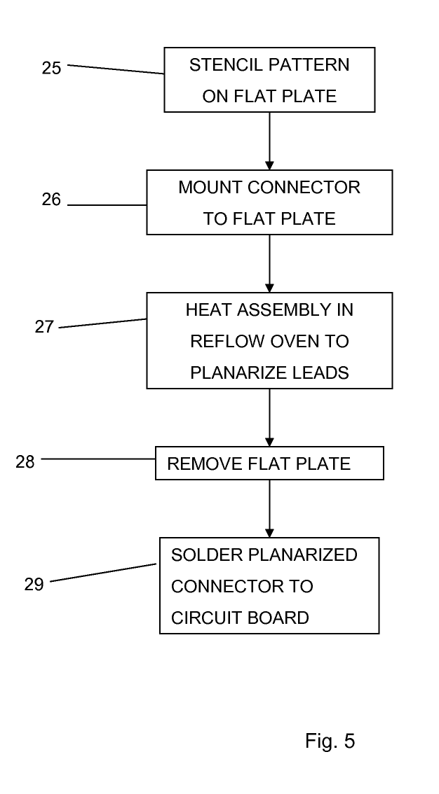

FIG. 5 illustrates one embodiment of planarization of connector leads in accordance with one embodiment of the present invention. It will be understood that the steps illustrated in FIG. 5 may be done at different times and places without departing from the invention. At 25, a solder paste pattern is stenciled onto a flat plate, as previously described. AT 26, the connector is connected to the flat plate as, for instance, with screws, as previously described. At 27, the assembly of the connector connected to the flat plate is heated in a reflow oven above the melt temperature of the lower melt solder particles, forming planarized leads, as described. At 28, the flat plate is removed, and at 29, the planarized connector is soldered to a circuit board by using, for instance, standard surface mount process to melt the higher melt solder particles in the solder paste, as previously described. In one embodiment, a thin layer of solder paste is stenciled onto a circuit board surface such that heating the layer while touching the contacts 14 to melt the higher melt solder particles will result in soldering the connector leads 12 to an electronic circuit on the circuit board.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A connector comprising:
a connector body;
connector leads extending from the connector body for solder connection to an electronic circuit wherein the connector leads do not extend a uniform distance from the body connector body; and
solder paste formed on each connector lead, said solder paste composed of first solder particles having a first lower melting point and second solder particles having a second higher melting point, said solder paste having been heated to said first melting point for adhering said solder paste to said connector leads while planarizing the solder covered electrical leads by forming the solder paste over said connection leads by stenciling said solder paste onto a flat plate which is non-wettable to said solder paste.

2. The connector of claim 1 wherein said connector leads are soldered to an electrical circuit by heating said solder paste to said second higher melting point.

3. The connector of claim 1 wherein the first solder particles are SnPbAg particles, and said second solder particles are SnPb particles.

4. The connector of claim 1 wherein said flat plate has a surface covered with a polymide film.

5. A connector comprising:
a flat plate that is non-wettable to solder;
solder paste stenciled on said flat plate in a predetermined pattern forming an arrangement of contacts on said flat plate;
a connector body;
connector leads extending from said connector body, said connector leads arranged in said predetermined pattern; and
guide blocks connected to said connector body and said flat plate such that each connector lead extends into a corresponding solder paste contact stenciled onto said flat plate,
said connector leads being wettable by said solder paste such that when said solder paste is heated sufficient to melt at least a portion of said solder paste, said solder paste contacts are soldered to said connector leads and planarized by said flat plate.

6. The connector of claim 5 wherein said solder paste includes first particles having a first lower melting point, and second particles having a second higher melting point, and wherein said solder paste is heated to said first lower melting point to solder the contacts to said connector leads.

7. The connector of claim 6 wherein said first particles are made of SnPbAg and said second particles are made of SnPb.

8. The connector of claim 5 wherein the surface of said flat plate is covered with polymide film.

9. The connector of claim 5 wherein, when the flat plate is removed and the solder paste is heated to the second higher melting point, said contacts being solderable to an electronic circuit.

10. The connector of claim 5 wherein said flat plate is attached to said support blocks by threadably engaging screws through said flat plate into said support blocks.

11. A method for forming a connector for connection to an electronic circuit, the method comprising:
stenciling solder paste contacts on a flat plate having a surface which is non-wettable by said solder paste, said solder paste having first solder particles having a lower first melting point and second solder particles having a higher second melting point;
mounting the flat plate to a connector body having connector leads extending from the connector body, said connector leads extending into corresponding solder paste contacts stenciled on the flat plate; and
heating said solder paste contacts to said lower first melting point thereby soldering the solder paste contacts to said connector leads.

12. The method of claim 11 wherein the height and volume of the solder paste contacts stenciled onto the flat plate are controlled such that the connector leads extending from the connector body extend into corresponding ones of the solder paste contacts.

13. The method of claim 11 wherein the first particles are SnPbAg and said second particles are SnPb.

14. The method of claim 11 wherein said the surface of said flat plate is covered with a polymide film.

15. The method of claim 11 wherein the solder paste contacts are heated by placing the connector body and mounted flat plate into a reflow oven.

16. The method of claim 11 wherein said flat plate is mounted to said connector body by threadably engaging screws through the flat plate into support blocks on said connector body.

17. The method of claim 11 further comprising removing the flat plate from the connector body thereby forming planarized connector leads extending from the connector body;

18. The method of claim 17 further comprising:
stenciling a thin layer of solder paste onto a circuit board in a pattern corresponding to the connector leads;
positioning said connector body with said planarized connector leads on said circuit board such that said planarized connector leads are in contact with the thin layer of solder paste pattern on said circuit board; and
soldering said planarized connector leads to the thin layer of solder paste.

19. The method of claim 18 wherein the planarized connector leads are soldered to the circuit board by a surface mount process.

20. The method of claim 18 further comprising providing an electronic circuit on said printed circuit to be soldered to the planarized connector leads of the connector.
